(19) United States
(12) Patent Application Publication
(10) Pub. No.: US 2025/0149849 A1
(43) Pub. Date: May 8, 2025

(54) METHOD AND APPARATUS FOR CONTROLLABLY ADJUSTING BEAM PARAMETERS

(71) Applicant: IPG PHOTONICS CORPORATION, Marlborough, MA (US)

(72) Inventors: Andrey MASHKIN, Burbach (DE); Fedor SHCHERBINA, Burbach (DE); ILYA ZAYTSEV, Burbach (DE)

(73) Assignee: IPG PHOTONICS CORPORATION, Marlborough, MA (US)

(21) Appl. No.: 18/727,789

(22) PCT Filed: Jan. 9, 2023
(86) PCT No.: PCT/US2023/010376

§ 371 Date: Jul. 10, 2024

(51) Int. Cl. H01S 3/23; H01S 3/067

(52) U.S. Cl. CPC H01S 3/23; H01S 3/06733

(57) ABSTRACT

A fiber laser source is configured with a plurality of individual fiber lasers which are coupled to one another in series. Each subsequent fiber laser is configured to transmit laser radiation of any of fiber laser or lasers located upstream therefrom. The switching among different operational regimes of the laser source, which includes SM, MM and different MMs and associated therewith beam shape, beam quality and power parameters is provided at high frequency corresponding to on/off switching of each individual fiber laser.

### BACKGROUND OF THE DISCLOSURE

### Field of the Disclosure

The present disclosure relates to fiber-laser technology. In particular, the disclosure relates to a fiber laser source configured to adjust spatial and/or divergence beam profile at high speed.

### Background Art Discussion

Welding, cutting, additive manufacturing are just a few widely used applications for industrial fiber lasers. Frequently, the task involving the use of fiber lasers requires dynamically adjusting numerous beam parameters including, among others, beam diameter and beam shape. For instance, the beam shape beneficial to selected cutting and welding operations often requires a combination of beams having respective Gaussian and ring-shaped intensity distributions which leads to high quality welds. A laser source realizing this combination may include two or more independent laser sources having respective outputs which are coupled into a fiber combiner dynamically controlling the beam profile. Referred to as the adjustable mode beam laser or AMB, such a source is disclosed in U.S. application Ser. No. 17/299,490 (U.S. patent application '490) incorporated herein by reference in its entirety. Alternatively, as disclosed in U.S. Pat. No. 10,732,440 (U.S. '440), which is also incorporated here by reference in its entirety, the laser source includes a mechanical means for pressuring a specifically configured fiber such that it outputs a beam with different characteristics.

The advantages of the output beam with controllably adjustable characteristics become particularly apparent in laser-based additive manufacturing (LBAM). The latter is a family of various processes including selective laser melting (SLM), where the laser beam melts the powder particles in a homogeneous mass, and/or selective laser sintering (SLS) in which the laser bears fuses power particles together. Historically realized by a numerous instruments which were used to mill, turn, cast, solder and more, LBAM uses a single tool—the laser beam that does it all.

For example, ceramic materials are conventionally processed through a powder metallurgy (PM) process, consisting of (1) powder production, (2) primary shaping, (3) de-binding. (4) furnace sintering and (5) final shaping. Primary shaping is traditionally done by slip casting or injection molding both technologically complex and time consuming techniques. Nowadays the primary shaping is done by SLM/SLS which allow shaping ceramic parts in geometries and forms that cannot be achieved by the traditional techniques.

Clearly, the LBAM has quite a few advantages over the traditional techniques including, but not limited to speed, cost and flexibility. One of the biggest advantages of the LBAM is rapid prototyping—the ability to design, manufacture and test a customized part in as little time as possible. Referring specifically to the manufacturing/production speed, a building rate of an individual part can be determined in accordance with the following:

$${V}_{b} = δ \times s \times ϑ ,$$

where
δ is the layer thickness; s is the hatch spacing and ϑ is the scanning speed.

The hatch spacing is the distance between the center lines of two successive laser scans, in other words, the hatch spacing determines the resolution of the process. Typically, the batch spacing is about 70% of the beam diameter on the surface of the laser treated powder. However, some regions of the part to be laser treated require a higher resolution which, in turn, requires a relatively low scan speed and high quality light that can be focused to a small spot. Others do not need high resolution and, as a consequence, can only benefit from higher scan speeds and light that has a beam spot larger than that required for delicate regions.

The industry, of course, is well aware of the above and has developed different techniques dealing with the “nonuniformity” of parts and hence laser beam characteristics needed to print them at high production speeds. For example, one technique utilizes uniformly configured multiple laser sources operating in parallel. The process speed is increased by a factor corresponding to the number of laser sources. If this approach appears to complicate the manufacturing process, it is because it does, and hence such a process entails high production costa. Still another approach provides for differently shaped beams delivered to the target by a single multi-clad fiber, as disclosed in U.S. patent application '490. In particular, the system implementing this approach is configured with bulk optics enlarging the beam diameter when the laser's output increases so as to treat selective regions of the part to be laser-printed. Conversely, with the output power decreased, the beam dimeter decreases when other regions of the same part require high resolution. Along with power and light quality, the system is operable to output differently shaped beams including, for example, a ring-shaped beam, flat-top beam, bell-shaped beam and others. Structurally, the system requires using one or more sophisticated kW power-level lasers which operate in parallel outputting high quality light which, for all practical purposes, is considered to be a single (transverse) fundamental mode (FM).

A need therefore exists for a fiber laser source having a simple configuration which is controllably operable to alter, among others, the beam diameter and beam shape.

### BRIEF SUMMARY OF THE DISCLOSURE

The disclosed laser source is based on a simple concept: two or more fiber lasers are coupled to one another in series and configured so that each subsequent fiber laser supports propagation of radiation which is output by one or more preceding upstream fiber lasers. The serially coupled fiber lasers each are configured with a set of optical characteristics including, among others, beam diameter, beam shape, optical power, emission wavelength, beam divergence (NA), and any combination thereof. The sets of optical parameters of respective fiber lasers are at least partially differ from one another which allows the shape, diameter and quality of the beam from the upstream fiber laser to remain intact as the beam propagates through at least one or more subsequent or downstream fiber lasers. Hence, the laser source operates in different regimes depending on which of upstream and downstream fiber lasers is at work. The principle of the disclosed laser source is similar to that of the nesting doll: each subsequent fiber laser has the structure allowing the radiation generated by one or more previous/upstream fiber lasers to propagate through its optical schematic and/or add something uniquely new to the laser source output.

In accordance with one exemplary implementation of the inventive concept, the laser source includes an upstream multi-clad multimode (MM) fiber laser and a downstream multi-clad single mode (SM) fiber laser. The refractive index profiles (RI) of respective upstream and downstream fiber lasers are configured such that in a MM operation of the laser source, the SM downstream fiber laser transmits the propagation of the flattop MM output from the upstream fiber laser without affecting its beam characteristics. In the SM regime of the laser source, only the downstream SM laser outputs the SM/FM bell-shaped beam with a small beam diameter. Still another regime includes simultaneous operation of both downstream and upstream lasers implementing the inventive concept, i.e., the flattop beam generated by the MM upstream laser is intact while propagating through the downstream laser, but along with the bell-shaped beam.

In another example, two or more MM fiber lasers are optically coupled in series. The laser source with two MM fiber lasers can operate in two different MM regimes which are characterized by respective flattop laser source output beams having, different diameters, with the beam diameter of the downstream fiber laser being smaller than that of the upstream fiber laser. The third regime including a simultaneous operation of both upstream and downstream fiber lasers includes two flattop source output beams generated simultaneously.

Still another example also relates to serially coupled MM fiber lasers. However, in contrast to the previously disclosed exemplary optical schematic, here both lasers have respective ring-shaped outputs with different dimensions. Again, the laser source output beam may include one or another ring-shaped beam or both concentrically output ring-shaped beams.

Regardless of the number of the fiber lasers constituting the laser source, respective RI profiles are structured so that each subsequent laser transmits light from any of the upstream fiber lasers while minimally affecting the beam optical quality, beam diameter and shape. For the inventive laser source to operate, serially coupled fiber lasers should generate respective beams with progressively decreasing beam dimeters with the smallest one being output by the downstream fiber laser.

Completing the fiber laser source is a delivery fiber which has a RI profile matching the shape of the output beam from either of the fiber lasers. As such, the delivery fiber may be configured to transmit a SM beam and/or MM beam, and different beam shapes in accordance with the desired configuration of the RI indices of respective fiber laser components of the disclosed laser source.

Based on the foregoing, fiber lasers of the disclosed laser source can be configured as multimode and/or single mode sources and polarized and non-polarized sources. The configuration of the disclosed fiber lasers may include a Fabry-Perot and/or ring resonators. The disclosed laser source is not limited to any particular power level and thus operates in a very broad range of powers from a few watts to kWs and, depending on the operational regime of any given laser source, up to one or more MWs. The operational regime may be selected from continuous wave (CW), quasi-CW (QCW) and pulsed laser operations. The active and passive fibers of respective fiber lasers may have an endless variety of the RI indices specifically tailored to obtain the desired shape and quality of the output beam. All of the above-disclosed laser configurations, as well as features disclosed above and discussed in detail below can be used in any combination with one another without deviating from the claimed subject matter of this disclosure.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various features and schematics and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1 illustrates an exemplary schematic of the disclosed laser source including serially coupled upstream MM and downstream SM fiber lasers;

FIG. 2 illustrates another exemplary schematic of the disclosed laser source configured with serially coupled upstream and downstream MM fiber lasers;

FIG. 3 illustrates an exemplary RI index profile of the MM active fiber of respective FIGS. 1 and 2;

FIG. 4 illustrates an exemplary RI index profile of a MM passive fiber utilized in combination with the active MM fiber of FIG. 3;

FIG. 5 illustrates an exemplary RI index profile of each of the input and output SM passive fibers operating in combination with the MM fiber laser of FIGS. 3 and 4;

FIG. 6 illustrates an exemplary RI index profile of the active SM fiber of FIG. 1 in combination with the RI profiles of respective FIGS. 3, 4 and 5;

FIG. 7 illustrates a ring-shaped RI profile of the MM fibers of FIGS. 1 and 2;

FIG. 8 illustrates still another RI profile of the MM fiber of FIGS. 1 and 2;

FIG. 9 illustrates a ring-shaped RI profile of the MM fiber laser of FIGS. 1 and 2; and

FIG. 10 illustrates a RI profile of the SM fiber laser of FIG. 1 that can operate in combination with the MM fiber laser of FIG. 9.

### SPECIFIC DESCRIPTION

The disclosed laser source offers the flexibility in structuring differently configured fiber lasers so as to tailor the source output beam to the existing needs. The concept underlying the inventive laser source provides for serially coupled fiber lasers wherein each subsequent fiber laser is configured to guide the beam generated by any of upstream fiber lasers without substantially affecting the beam's optical characteristics. In addition, each subsequent laser is structured to output its own beam having a beam diameter smaller than that this fiber laser transmits. The fiber lasers each can operate in a regime selected from CW, QCW and pulsed regimes. The disclosed laser source can include at least two or more fiber lasers operating in respective regimes which are either the same or different from one another. Also, multiple fiber lasers of the disclosed laser source may generate light at the same or different emission wavelengths and/or same or different powers.

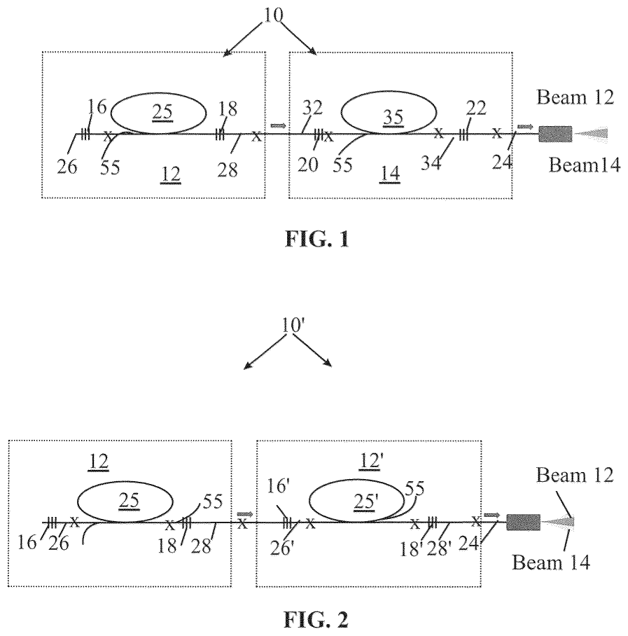

Turning to FIG. 1, one configuration of the disclosed laser source 10 is just a structural example of otherwise limitless schematics which one of ordinary skill in the fiber laser arts can design utilizing the disclosed concept. In particular, laser source 10 includes two light generators or fiber lasers 12 and 14 with the former being an upstream MM fiber laser and latter being a SM downstream fiber laser. In the illustrated schematic, SM downstream laser 14 is coupled to a passive delivery fiber 24.

The lasers 12, 14 have respective all fiber Fabry-Perot resonating cavities configured with respective sets of three fibers: a gain medium or active fiber 25, 35, passive input fibers 26, 32 and output passive fibers 28, 34. The active fiber of each set has its opposite ends butt spliced to respective input and output passive fibers, and is doped with ions of laser-active rare-earth elements. The following non-exclusive list of typical lanthanides in glasses includes ions of ytterbium (Yb), erbium (Er), thulium (Tm), neodymium (Nd), holmium (Ho), praseodymium (Pr), cerium (Ce), different co-doping combinations and others. The passive fibers are universally utilized in fiber lasers since technologically it is easier to write fiber Bragg gratings (FBG) in passive fibers. Accordingly each of the shown resonating cavities is defined between upstream high reflection FBG and downstream weak FBG. Specifically, MM upstream laser 12 has its resonant cavity defined between FBGs 16 and 18, whereas SM laser 14 is formed with a resonant cavity defined between FBGs 20 and 22. The two pairs of FBGs—16, 18 and 20, 22 respectively are configured differently with the FBGs 16 and 18 being MM, whereas the other pair of FBGs 20 and 22 are SM. The delivery fiber 24 is spliced to output passive fiber 34 of SM laser 14 and configured to output the SM or MM or both SM and MM source output beams as disclosed below.

For the operation in SM, only downstream SM fiber laser 14 is pumped to generate signal Beam O14. Alternatively, to generate only a MM output beam O12 at the output of laser source 10, MM upstream laser 12 generates a MM signal which is coupled into downstream SM laser 14 which is de-energized during the operation of laser 12. The SM fiber laser 14 transmits the coupled MM beam along the light path which further includes delivery fiber 24, without affecting the beam optical characteristics. The simultaneous operation of fiber lasers 12, 14 respectively provides both. MM and SM source outputs. Based on the foregoing, the alternative or simultaneous energizing of fiber laser components 12 and 14 provides for the laser source output beam O12/O14 with at least two or more desired optical characteristics. Particularly, the characteristics include, among others, the M² factor, beam shape which is, for example, bell-shaped or flattop or ring-shaped, and power which is adjusted by controlling pump power of each fiber laser individually.

FIG. 2 illustrates another exemplary schematic configured in accordance with the disclosed concept. Similarly to FIG. 1, laser source 10′ includes two fiber lasers 12 and 12′, but in contrast to the configuration of FIG. 1, both fiber upstream and downstream lasers 12 and 12′ respectively are MM. The operational principle of the illustrated laser 10′ is similar to that of FIG. 1: downstream fiber laser 12′ transmits the output beam O12 of upstream MM fiber laser 12. Alternatively, downstream MM fiber laser 12′ generates its own MM output beam O14, but with the beam diameter smaller than that of beam O12 from upstream MM fiber laser 12. Finally, both MM fiber lasers 12 and 12′ respectively can operate simultaneously contributing to the laser source output beam including the beam O12 from upstream MM laser 12 and beam O14 from downstream MM laser 12′.

Both FIGS. 1 and 2 each illustrate the use of pumps 55 which include diode lasers or other types of pump lasers. Typically the pumping arrangement includes side pumping with pump light coupled into the outer clad of double-clad active fibers 25, 25′ and 35 and propagating in a zig-zag fashion across the fiber area, as well known to one of ordinary skill in the fiber art. However, the end pumping scheme can be used as well. Pump light may be coupled into the gain medium so that it co-propagates with the generated signal light or counter-propagates or both. The pumps 55 can energize only the designated fiber laser and thus are controlled individually. The control can be also realized by a central processing unit to achieve the desired combination of SM and MM light powers. One of ordinary skill in the art readily realizes that a combination of more than two fiber lasers, such as multiple upstream MMs and downstream SM or all MM lasers, can be easily configured based on the disclosed concept.

The remaining portion of this application discloses a fiber structure making the disclosed concept work. One of salient structural features realizing the disclosed concept is the RI profile of the fiber components tailored to obtain the desired output beam characteristics of laser source 10.

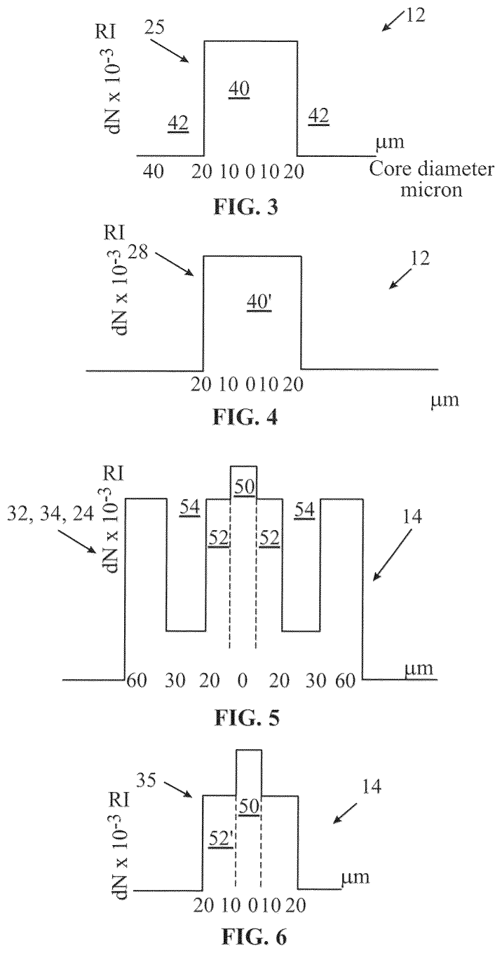

Referring to FIGS. 3 and 4 in combination with FIG. 1, active fiber 25 of upstream MM fiber laser 12 may have a single or multi-clad configuration. As shown, the RI of fiber 25 includes a core 40 doped with ions of rare-earth elements and concentrically surrounded by a clad 42 which, in torn, may be surrounded by a polymeric protective sleeve not shown here. Pumped in accordance with a parallel or end-pump arrangement, the light generated in core 40 of active fiber 25 is coupled into a core 40′ of output passive fiber 28, as illustrated in FIG. 4. The cores 40 and 40′ of respective active and passive fibers 25, 28 are dimensioned to have matching core diameters and NAs to prevent light losses. The light output from passive fiber 28 of laser 12 is coupled into input passive fiber 32 of SM downstream fiber laser 14.

FIG. 5 illustrates a RI of fibers 32, 35 and 34 of downstream SM fiber laser 14 seen in FIG. 1. In other words, all three fibers have a uniform RI, and while the following discussion is based on input passive fiber 32, it invariably relates to other two fibers 35 and 34, respectively. Based on the illustration, input passive fiber 32 of SM fiber laser 14 has a core 52 receiving MM radiation from core 40′ of output passive fiber 28 of upstream fiber laser 12 of FIGS. 1 and 4. The cores 40′ and 52 of respective fiber laser 12, 14 are configured with a uniform numerical aperture (NA) and uniform outer diameters so as to minimize and preferably completely prevent coupling light losses. An annular dip 54 of the RI of SM input fiber 32 of FIG. 5 is formed by glass, such as SiO₂/SiF, wherein F is fluorine, and functions as a barrier confining the guided radiation to inner core 52. The cores of all three fibers of downstream laser 14 each have a central core region 50 which has an elevated RI compared to that of core 52.

Referring to FIG. 6 in addition to all of the above discussed figures, the MM radiation guided in core 52 including central region 50 of passive input fiber 32 of downstream laser 14 is further coupled into an inner clad 52′ and central region 50 of active fiber 35. Due to the uniformity of all fiber components of downstream fiber laser 14, the resonator's inner losses of the light propagating though these fibers are substantially eliminated. As one of ordinary skill in the fiber laser art readily understand, central core regions 50 of respective passive and active fibers of downstream SM fiber laser 14 do not affect the output of upstream MM fiber laser 12, which has a flattop shape. Guided further through delivery fiber 24, the configuration of which is disclosed below, the MM radiation with a flattop beam shape is output from laser source 10.

The operation of laser source 10 of FIG. 1 in SM is realized by energizing only downstream fiber laser 14. The central core region 50 of each of input and output passive fibers 32, 34 respectively is made, for example, from glass SiO₂/GeO₂, wherein Ge is germanium or other known elements, providing this central core region with a raised RI. In addition, central core region 50 of active fiber 35 in FIG. 6 is doped with light-emitting ions. The FBGs 20 and 22 respectively of FIG. 1 are written in central core regions 50 of respective input and output passive fibers 32, 34 of SM fiber laser 14. Accordingly, when the operation of laser source of FIG. 1 is required to be only in a SM, upstream MM fiber laser 14 is de-energized. If the operation of laser source 10 requires a source output including outer MM flattop and inner SM bell-shaped beams, both upstream and downstream fiber lasers 12, 14 respectively operate simultaneously.

Referring to FIGS. 1 and 6, a few words should be said about SM fiber lasers. Within the context of this disclosure all of the fibers—passive and active—are MM fibers, i.e., the cores of all fibers can support multiple modes. What makes SM fiber laser 14 output radiation substantially in a fundamental mode (FM) at the desired wavelength is a careful selection of the waveguide geometry and NA which allows the waveguide to support substantially only a FM, as known to one of ordinary skill. Among multiple modes reflected from FBGs 20, 22 into the resonator, the FM has the highest coefficient of reflection. Hence, the FM reaches the lasing threshold first. Accordingly, SM fiber laser 14 outputs a beam substantially in a single FM with M²≤1.3 which for all practical purposes is considered and referred to as SM.

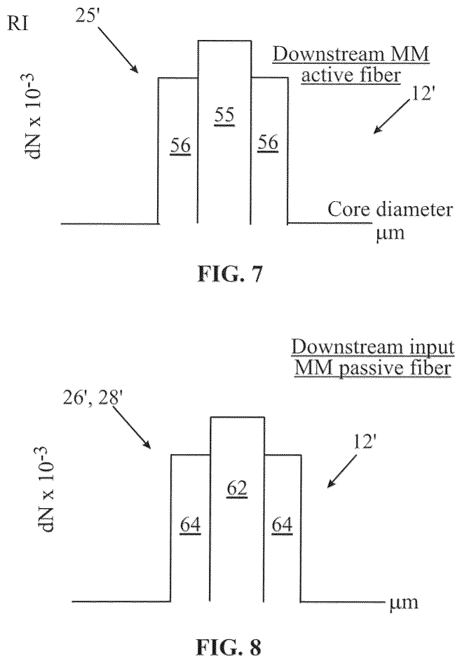

The MM-MM configuration of laser source 10′ shown in FIG. 2 can be realized by a combination of RIs of respective FIGS. 3-4 and FIGS. 7 and 8. In particular as shown in FIG. 7, active fiber 25′ of downstream MM fiber laser 12′ may have a double clad configuration with a central core region 52 provided within inner clad 54. The input and output passive fibers 26′ and 28′ of FIG. 2 each include central core region 62 within and inner clad 64 (FIG. 8). For downstream MM fiber laser 12′ of FIG. 2 to transmit radiation from upstream MM laser 12 of FIGS. 2-4, input and output passive fibers 26′, 28′ and active fiber 25′ (FIGS. 8 and 7) have respective inner clads 64, 54 provided with the diameters that match those of respective cores 40 of FIGS. 4 and 3.

If the operation of laser source 10′ is required in MM radiation which is output from, for example, only downstream MM fiber laser 12′, than the latter is energized and upstream MM fiber laser 12 is de-energized. The only difference in the discussed schematic of FIG. 2 between upstream and downstream MM lasers 12, 12′ respectively is the diameter of cores 52, 62 of respective active fibers 25, 25′ with the core of downstream MM laser 12′ being somewhat smaller than that of upstream MM laser 12. If only the upstream MM fiber laser 12 operates, then downstream MM fiber laser 12′ is shut down. Alternatively, both MM fiber lasers 12 and 12′ can operate in tandem with the flattop beam O14 of upstream MM laser 12 of FIG. 2 surrounding the output flattop beam O12 of downstream MM laser 12′.

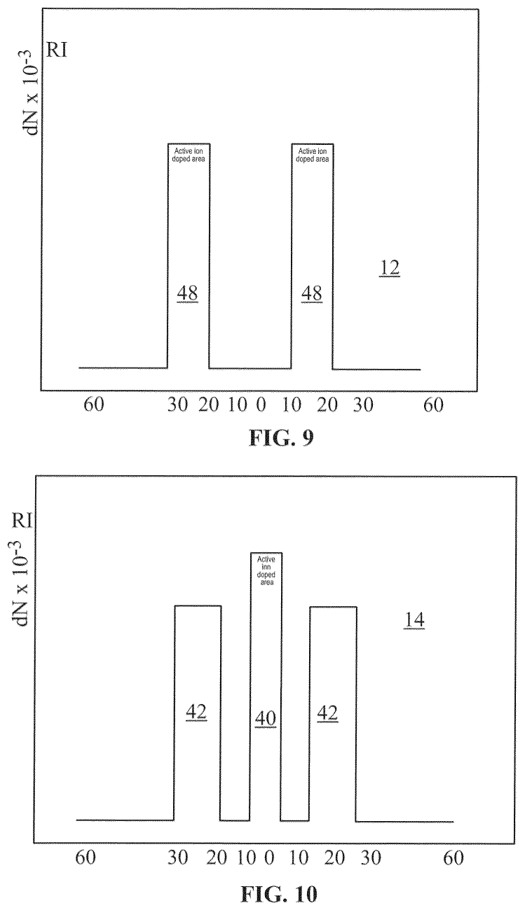

Referring to FIGS. 9 and 1, the above-discussed flattop-shaped MM beam is not the only shape upstream MM fiber laser 12 of FIGS. 1 and 2 can output. In particular, the RI profile shown in FIG. 9 is fabricated in fibers when the output beam is required to have a ring shape. The ring core 48 includes RI raising additives and light emitting dopants. The upstream MM fiber laser 12 with the RI profile of FIG. 9 can be used in combination with SM downstream fiber laser 14 having a RI profile as shown in FIG. 10. In particular, a ring-shaped beam from upstream MM laser 12 is transmitted through ring core 42 of downstream SM laser 14. Accordingly, a combination of upstream and downstream fiber lasers 12 and 14 respectively with corresponding RI profiles of FIGS. 9, 10 provides the output beam of laser source 10 with a ring shape, when only MM laser 14 operates, bell-shaped beam if downstream laser 14 operates alone or both. One of ordinary skill will be able to select appropriate RI profiles of passive fiber to provide the desired optical connection between MM and SM lasers of respective FIGS. 9 and 10 and SM fiber laser 12 and delivery fiber 24 based on the underlying inventive concept of this disclosure.

The aspects disclosed herein in accordance with the present invention, are not limited in their application to the details of construction and the arrangement of components set forth in the following description or illustrated in the accompanying drawings. These aspects are capable of assuming other embodiments and of being practiced or of being carried out in various ways. Examples of specific implementations are provided herein for illustrative purposes only and are not intended to be limiting. In particular, acts, components, elements, and features discussed in connection with any one or more embodiments are not intended to be excluded from a similar role in any other embodiments. For example, while the disclosure concentrates mainly on the beam shape, light quality and power, obvious derivatives of the disclosed parameters are readily apparent to one of ordinary skill. For example, knowing the beam shape, it is easy to determine a beam diameter and, as a consequence, the beam divergence for any given wavelength, etc.

Also, the phraseology and terminology used herein is for the purpose of description and should not be regarded as limiting. References in the singular or plural form are not intended to limit the presently disclosed systems or methods, their components, acts, or elements. In addition, in the event of inconsistent usages of terms between this document and documents incorporated herein by reference, the term usage in the incorporated reference is supplementary to that of this document; for irreconcilable inconsistencies, the term usage in this document controls.

Having thus described several aspects of at least one example, one of ordinary skill in the art readily appreciates that various alterations, modifications, and improvements will readily occur to those skilled in the art. The number of fiber lasers, of course, can be well in excess of two. In fact, the disclosed laser source is modular and thus can have additional fiber laser components added to the disclosed above which, in turn can be substituted if need arises. For example, the number of concentric cores in the shown RI profiles is limited only by a common sense. Additional examples of RI profiles are disclosed in U.S. Pat. No. 10,732,440 which is fully incorporated herein by reference. The examples disclosed and their obvious alterations, modifications and improvements, which are all part of this disclosure, are applicable in a variety of industrial applications. Accordingly, the foregoing description and drawings are by way of example only.

1. A fiber laser source comprising:
upstream and downstream fiber lasers optically coupled to one another in series and controllable to generate respective first and second beams, the downstream fiber laser being configured to transmit a first beam, wherein the first and second beams each are characterized by a parameter including a beam shape, beam quality, power, wavelength or a combination thereof; and
a delivery fiber optically coupled to an output of the downstream fiber laser and configured to transmit the first beam or the second beam or the first and second beams simultaneously.

2. The fiber laser source of claim 1 further comprising an additional upstream fiber laser generating a third laser beam which is transmitted through the upstream and downstream fiber lasers and the delivery fiber alone or in combination with the first beam or second beam or with the first and second beams.

3. The fiber laser source of claim 1, wherein at least one or more of the beam shape, beam quality, wavelength and power of respective first, second and third beams are different from one another.

4. The fiber laser source of claim 1, wherein the downstream fiber laser is configured to generate the second beam in a fundamental transverse mode (FM) or in multiple transverse modes (MM), the first beam output by the upstream fiber laser being MM.

5. The fiber laser source of claim 1, wherein the upstream and downstream fiber lasers are configured to generate respective first and second beams each having a bell, flattop or ring shape.

6. The fiber laser source of claim 1, wherein the upstream and downstream lasers are configured to generate respective first and second beams with the second beam having a beam diameter smaller than that of the first beam.

7. The fiber laser source of claim 1 further comprising a plurality of optical pumps designated to energize respective upstream and downstream fiber lasers.

8. The fiber laser source of claim 7, wherein the pumps are individually controlled and each is selected from a diode laser or fiber laser or a combination of these.

9. The fiber laser source of claim 7 further comprising a central processing unit operative connected to the pumps and configured to control an on/off state of each of the pumps.

10. The fiber laser source of claim 1, wherein the upstream and downstream fiber lasers each are configured with spaced input and output passive fibers and an active fiber, opposite ends of the active fiber being spliced to respective opposing ends of the input and output passive fibers, the passive fibers flanking each of the upstream and downstream fiber lasers having respective fiber Bragg Gratings (FBG), each pair of FBGs defining a resonator cavity there between which includes the active fiber.

11. The fiber laser source of claim 10, wherein the passive and active fibers of the upstream fiber laser each are configured to transmit MM laser radiation, the passive and active fibers of the upstream fiber laser having respective cores configured with a uniform core diameter.

12. The fiber laser source of claim 11, wherein the downstream fiber laser includes the active and passive fibers each having a multi-clad configuration which includes a central core and an inner clad, the inner clad being dimensioned with a clad diameter matching the uniform core diameter of the active and passive fibers of the upstream fiber laser, the cores of respective active and passive fibers of the downstream fiber laser being dimensioned to transmit a FM or MM.

13. The fiber laser source of claim 12, wherein the passive and active fibers of the downstream fiber laser, which operates in FM, have respective mode field diameters matching one another.

14. The fiber laser source of claim 1, wherein the laser source outputs a source beam in the FM, MM or FM and MM or multiple MMs.

15. The fiber laser source of claim 12, wherein the cores and inner cores of respective active fibers are selectively doped with ions of one or more rare-earth metals.

16. The fiber laser source of claim 1, wherein the upstream and downstream fiber lasers operate at respective wavelengths which are the same or different from one another.

17. The fiber laser source of claim 1, wherein the delivery fiber is a multi-clad passive fiber.
